(19) United States
(12) Patent Application Publication
(10) Pub. No.: US 2005/0259865 A1
(43) Pub. Date: Nov. 24, 2005

(54) Object classification via time-varying information inherent in imagery

(75) Inventors: Srinivas Gutta, Yorktown Heights, NY (US); Vasanth Philomin, Aachen (DE); Miroslav Trajkovic, Ossining, NY (US)

Correspondence Address: c/o U.S. PHILIPS CORPORATION;INTELLECTUAL PROPERTY DEPARTMENT, 580 WHITE PLAINS ROAD, TARRYTOWN, NY, 10591, US

(73) Assignee: Koninklijke Philips Electronics N.V.

(21) Appl. No.: 10/295,649

(22) Filed: Nov. 15, 2002

(51) Int. Cl. G06K 9/62

(52) U.S. Cl. 382/156

(57) ABSTRACT

A method for classifying objects in a scene, is provided. The method including: capturing video data of the scene; locating at least one object in a sequence of video frames of the video data; inputting the at least one located object in the sequence of video frames into a time-delay neural network; and classifying the at least one object based on the results of the time-delay neural network.

### BACKGROUND OF THE INVENTION

1. Field of the Invention

The present invention relates generally to computer vision, and more particularly, to object classification via time-varying information inherent in imagery.

2. Prior Art

In general, identification and classification systems of the prior art identify and classify objects, respectively, either on static or video imagery. For purposes of the present disclosure, object classification shall include object identification and/or classification. Thus, the classification systems of the prior art operate on a static image or a frame in a video sequence to classify objects therein. These classification systems known in the art do not use time varying information inherent in the video imagery, rather, they attempt to classify objects by identifying objects one frame at a time.

While these classification systems have their advantages, they suffer from the following shortcomings:
(a) As classification is performed on each frame independently, any relation between objects across frames is lost;
(b) Since pixel dependency across frames is no longer maintained as each frame is treated independently, overall performance of a classification system is no longer robust; and
(c) They do not exhibit graceful degradation due to noise and illumination changes inherent in the imagery.

In Bruton et al., On the Classification of Moving Objects in Image Sequences Using 3D Adaptive Recursive Tracking Filters and Neural Networks, 29^{th} Asilomar Conference on Signals, Systems and Computers, the trajectories of vehicles that pass thorough a busy intersection are classified. Specifically, this paper is particularly concerned with classifying the following four kinds of vehicle trajectories—“vehicle turning left”, “vehicle going straight from the left lanes”, “vehicle turning right” and “vehicle going straight from the right lanes”. The strategy for achieving this is as follows: (a) use recursive filters to locate the object in a video frame, (b) use the same filters to track the objects on successive frames, (c) next, extract the centroid and velocity of the object from each frame, (d) use the extracted velocity and pass it to a Time-Delay Neural Network (TDNN) to obtain a static velocity profile, and (e) use the static velocity profile to train a Multi-Layer Perceptron (MLP) to finally classify the trajectories. There are two primary problems with this classification scheme. The prior art uses a filter, specifically a passband filter to locate and track objects. The parameters of the passband filter are set in a adhoc fashion. However as the inter-relation of the pixels across frames are not taken into account for locating and tracking of objects, the overall performance of such a system would degrade as noise across frames would not be consistent. Therefore learning a background model across a set of frames provides an alternative way for efficient location and tracking of objects of interest. Also, learning the model becomes especially important because it is often the case that there are always changes in illumination in video imagery when they are acquired during different times. Secondly, because of the illumination changes, the velocity calculations will not be efficient. Because of this, the overall accuracy of the neural network itself will be bad.

### SUMMARY OF THE INVENTION

Therefore it is an object of the present invention to provide methods and devices for object classification that overcome the disadvantages associated with the prior art.

Accordingly, a method for classifying objects in a scene is provided. The method comprising: capturing video data of the scene; locating at least one object in a sequence of video frames of the video data; inputting the at least one located object in the sequence of video frames into a time-delay neural network; and classifying the at least one object based on the results of the time-delay neural network.

Preferably, the locating comprises performing background subtraction on the sequence of video frames.

The time-delay neural network is preferably an Elman network. The Elman network preferably comprises a Multi-Layer Perceptron with an additional input state layer that receives a copy of activations from a hidden layer at a previous time step as feedback. In which case the classifying comprises traversing the state layer to ascertain an overall identity by determining a number of states matched in a model space.

Also provided is an apparatus for classifying objects in a scene where the apparatus comprises: at least one camera for capturing video data of the scene; a detection system for locating at least one object in a sequence of video frames of the video data and inputting the at least one located object in the sequence of video frames into a time-delay neural network; and a processor for classifying the at least one object based on the results of the time-delay neural network.

Preferably, the detection system performs background subtraction on the sequence of video frames.

The time-delay neural network is preferably an Elman network. The Elman network preferably comprises a Multi-Layer Perceptron with an additional input state layer that receives a copy of activations from a hidden layer at a previous time step as feedback. In which case the processor classifies the at least one object by traversing the state layer to ascertain an overall identity by determining a number of states matched in a model space.

Also provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flowchart of a preferred implementation of a method of the present invention.

FIG. 2 illustrates a schematic illustration of a system for carrying out the methods of the present invention.

### DETAILED DESCRIPTION OF THE PREFERRED EMBODIMENT

Although this invention is applicable to numerous and various types of neural networks, it has been found particularly useful in the environment of the Elman Neural Network. Therefore, without limiting the applicability of the invention to the Elman Neural Network, the invention will be described in such environment.

As opposed to classifying objects in video imagery one frame at a time, the methods of the present invention label video sequence in its entirety. This is achieved through the use of a Time Delay Neural Network (TDNN), such as an Elman Neural Network that learns to classify by looking at past and present data and their inherent relationships to arrive at a decision. Thus, the methods of the present invention have the ability to identify/classify objects by learning on a video sequence as opposed to learning from discrete frames in the video sequence. Furthermore, instead of extracting feature measurements from the video data, as is done in the prior art discussed above, the methods of the present invention use the tracked objects directly as input to the TDNN. In short, the prior art has used a TDNN whose input is the features extracted from the tracked objects. In contrast to the prior art, the methods of the present invention input the tracked objects themselves to the TDNN.

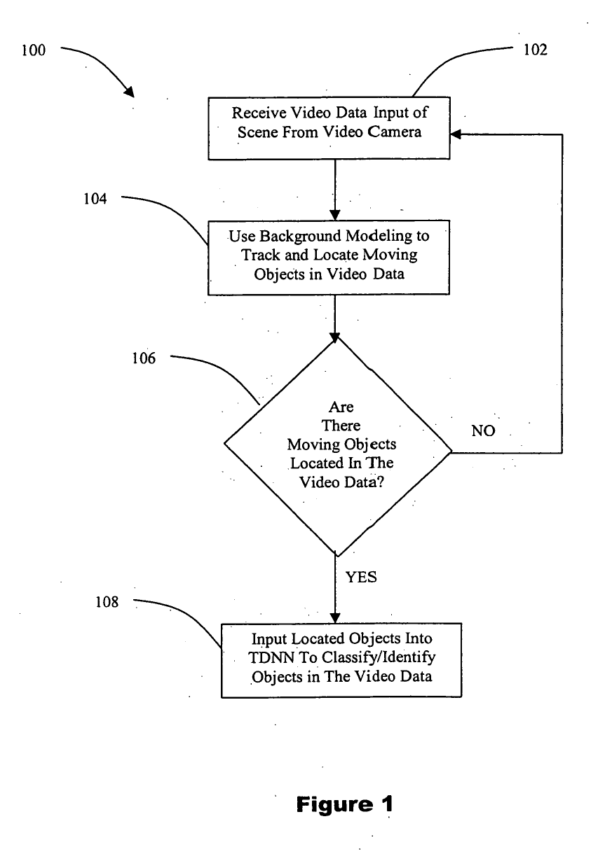

The methods of the prior art will now be described with reference to FIG. 1. FIG. 1 shows a flowchart illustrating a preferred implementation of the methods of the present invention, referred to generally therein by reference numeral 100. In the method, video input is received at step 102 from at least one camera that captures video imagery from a scene. A background model is then used at step 104 to locate and track objects in the video imagery across the camera's field of view. Background modeling to track and locate objects in video data is well known in the art, such as that disclosed in U.S. patent application Ser. No. 09/794,443 to Gutta, et al. entitled Classification Of Objects Through Model Ensembles, the contents of which are incorporated herein by reference; Elgammal et al., Non-parametric Model for Background Subtraction, European Conference on Computer Vision (ECCV) 2000, Dublin, Ireland, June 2000; and Raja et al., Segmentation and Tracking Using Colour Mixture Models, in the Proceedings of the 3rd Asian Conference on Computer Vision, Vol. I, pp. 607-614, Hong Kong, China, January 1998.

If no moving objects are located in the video data of the scene, the method proceeds along step 106—NO to step 102 where the video input is continuously monitored. If moving objects are located in the video data of the scene, the method proceeds along step 106—YES to step 108 where the located objects are input directly to a Time-Delay Neural Network (TDNN), preferably, an Elman Neural Network (ENN). A preferred way of achieving this is through the use of Elman Neural Networks [Dorffner G., Neural Networks for Time Series Processing, Neural Networks 3(4), 1998]. The Elman network takes as input two or more video frames and preferably, the entire sequence as opposed to dealing with individual frames. The basic assumption is that time varying imagery can be described as a linear transformation of a time-dependent state—given through a state vector \vec{s}:
\vec{x}(t)=C\vec{s}+(t)+ε(t) (1)
where C is a transformation matrix. The time-dependent state vector can also be described by a linear model:
   \vec{s}(t)=A\vec{s}(t−1)+B\vec{η}(t) (2)
where A and B are matrices, and \vec{η}(t) is noise process, just like \vec{ε}(t) above. The basic assumption underlying this model is the markov assumption—the state can be identified no matter how the state was reached. If it is further assumed that the states are also dependent on the past sequence vector, and neglect the moving average term B\vec{η}(t):
   \vec{s}(t)=A\vec{s}(t−1)+D\vec{x}(t−1) (3)
then an equation describing a recurrent neural network type is obtained, known as an Elman network. The Elman network is a Multi-Layer Perceptron (MLP) with an additional input layer, called the state layer, receiving as feedback a copy of the activations from the hidden layer at the previous time step.

Once the model is learned, recognition involves traversing the non-linear state-space model to ascertain the overall identity by finding out the number of states matched in that model space. Such an approach can be used in a number of domains, such as detection of slip and fall events in retail stores, recognition of specific beats/rhythms in music, and classification of objects in residential/retail environments.

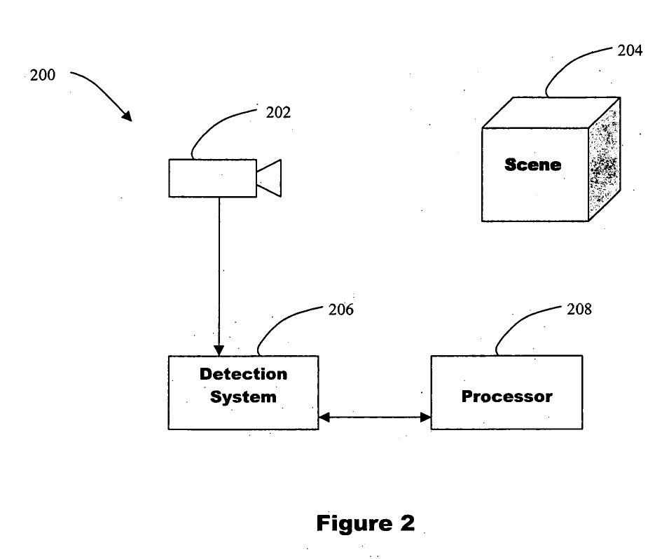

Referring now to FIG. 2, there is illustrated a schematic representation of an apparatus for carrying out the methods 100 of the present invention. The apparatus being generally referred to by reference numeral 200. Apparatus 200 includes at least one video camera 202 for capturing video image data of a scene 204 to be classified. The video camera 202 preferably captures digital image data of the scene 204 or alternatively, the apparatus further includes a analog to digital converter (not shown) to convert the video image data to a digital format. The digital video image data is input into a detection system 206 for detection of moving objects therein. Any moving objects detected by the detection system 206 is preferably input into a processor 208, such as a personal computer, for analyzing the moving object image data and performing the classification analysis for each of the extracted features according to the method 100 described above.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for classifying objects in a scene, the method comprising:
capturing video data of the scene;
locating at least one object in a sequence of video frames of the video data;
inputting the at least one located object in the sequence of video frames into a time-delay neural network; and
classifying the at least one object based on the results of the time-delay neural network.

2. The method of claim 1, wherein the locating comprises performing background subtraction on the sequence of video frames.

3. The method of claim 1, wherein the time-delay neural network is an Elman network.

4. The method of claim 3, wherein the Elman network comprises a Multi-Layer Perceptron with an additional input state layer that receives a copy of activations from a hidden layer at a previous time step as feedback.

5. The method of claim 4, wherein the classifying comprises traversing the state layer to ascertain an overall identity by determining a number of states matched in a model space.

6. A program storage device readable by machine, tangibly embodying a program of instructions executable by the machine to perform method steps for classifying objects in a scene, the method comprising:
capturing video data of the scene;
locating at least one object in a sequence of video frames of the video data;
inputting the at least one located object in the sequence of video frames into a time-delay neural network; and
classifying the at least one object based on the results of the time-delay neural network.

7. The program storage device of claim 6, wherein the locating comprises performing background subtraction on the sequence of video frames.

8. The program storage device of claim 6, wherein the time-delay neural network is an Elman network.

9. The program storage device of claim 8, wherein the Elman network comprises a Multi-Layer Perceptron with an additional input state layer that receives a copy of activations from a hidden layer at a previous time step as feedback.

10. The program storage device of claim 9, wherein the classifying comprises traversing the state layer to ascertain an overall identity by determining a number of states matched in a model space.

11. A computer program product embodied in a computer-readable medium for classifying objects in a scene, the computer program product comprising:
computer readable program code means for capturing video data of the scene;
computer readable program code means for locating at least one object in a sequence of video frames of the video data;
computer readable program code means for inputting the at least one located object in the sequence of video frames into a time-delay neural network; and
computer readable program code means for classifying the at least one object based on the results of the time-delay neural network.

12. The computer program product of claim 11, wherein the computer readable program code means for locating comprises computer readable program code means for performing background subtraction on the sequence of video frames.

13. The computer program product of claim 11, wherein the time-delay neural network is an Elman network.

14. The computer program product of claim 13, wherein the Elman network comprises a Multi-Layer Perceptron with an additional input state layer that receives a copy of activations from a hidden layer at a previous time step as feedback.

15. The Computer program product of claim 14, wherein the computer readable program code means for classifying comprises computer readable program code means for traversing the state layer to ascertain an overall identity by determining a number of states matched in a model space.

16. An apparatus for classifying objects in a scene, the apparatus comprising:
at least one camera for capturing video data of the scene;
a detection system for locating at least one object in a sequence of video frames of the video data and inputting the at least one located object in the sequence of video frames into a time-delay neural network; and
a processor for classifying the at least one object based on the results of the time-delay neural network.

17. The apparatus of claim 16, wherein the detection system performs background subtraction on the sequence of video frames.

18. The apparatus of claim 16, wherein the time-delay neural network is an Elman network.

19. The apparatus of claim 18, wherein the Elman network comprises a Multi-Layer Perceptron with an additional input state layer that receives a copy of activations from a hidden layer at a previous time step as feedback.

20. The apparatus of claim 19, wherein the processor classifies the at least one object by traversing the state layer to ascertain an overall identity by determining a number of states matched in a model space.
